(19) United States
(12) Patent Application Publication
(10) Pub. No.: US 2022/0309469 A1
(43) Pub. Date: Sep. 29, 2022

(54) COMPARING JOB SEEKERS AND JOBS BY PARAMETERIZING BOTH JOB DESCRIPTIONS AND JOB SEEKER DESCRIPTIONS TO A COMMON SET OF PARAMETERS

(71) Applicant: JOB-SET, LLC, El Campo, TX (US)

(72) Inventors: Peter Joseph Photos, Boerne, TX (US); Francois Auzerais, Westport, CT (US)

(73) Assignee: JOB-SET, LLC, El Campo, TX (US)

(21) Appl. No.: 17/839,438

(22) Filed: Jun. 13, 2022

Related U.S. Application Data
(63) Continuation of application No. 15/656,650, filed on Jul. 21, 2017.
(60) Provisional application No. 62/364,915, filed on Jul. 21, 2016.

(51) Int. Cl. G06Q 10/10; G06F 16/2457; G06F 16/9535

(52) U.S. Cl. CPC G06Q 10/1053; G06F 16/24578; G06F 16/24575; G06F 16/9535

(57) ABSTRACT

Job seekers and available jobs are compared by parameterizing job seeker factual data, job seeker assessed data and the descriptions of available jobs to a common set of well-defined parameters. The common set of well-defined parameters may be derived from a set of generic job descriptions. The output may include parameterization profiles of available jobs and job seekers, and/or a ranked list of parameterized available jobs for a parameterized job seeker or a ranked list of parameterized job seekers for a parameterized available job.

### CROSS-REFERENCE TO RELATED APPLICATIONS

This application is a continuation of U.S. patent application Ser. No. 15/656,650, filed Jul. 21, 2017, which claims the benefit of and priority to U.S. Provisional Patent Application 62/364,915 titled A System and Method to Match People and Jobs Using Machine Artificial Intelligence, filed Jul. 21, 2016, the entire contents of both of which are incorporated herein by reference.

### FIELD

Aspects of the present disclosure include a method and system for management of human resources. More particularly, aspects are related to computerized skill-based comparison, such as via a job-related API or data structure, of a person to a job, or a job to a person, or a person to a person, or a job to a job using a common set of well-defined parameters.

### BACKGROUND

Computerized job finding systems such as career placement tools are known. Many of the known systems will only present jobs of a specific type that is identified by a job seeker. Consequently, the job seeker must know the specific type of job for which they are qualified and in which they are interested, or what specific career they intend to pursue. This may be problematic because a job seeker may not know which type of job might be suitable. A further complication is that job descriptions, resumes and curriculum vitae tend to obscure the basic requirements of the job and basic competencies of the job seeker. For example, the job seeker may use different terminology than is used in some job descriptions. Words that have multiple meanings with respect to different job requirements or skills may also be troublesome for systems that rely on keyword matching. Moreover, known systems may pigeonhole job seekers as being suitable for only a single type of job based on most recent experience even though some job seekers may be qualified for a variety of different types of jobs. Consequently, it can be difficult to provide a complete and meaningful optimal comparison of people with available jobs.

### SUMMARY

All examples, aspects, and features mentioned in this document can be combined in any technically possible way.

Aspects of this disclosure relate to a job matching method and system that creates parameterized descriptions of available jobs, i.e. descriptions of positions for which a suitable applicant is sought, and descriptions of job seekers, i.e. information about individuals seeking jobs, using a common set of well-defined parameters based on known job descriptions, i.e. existing descriptions of jobs in general, or for which no applicants are currently being sought. The descriptions of available jobs may be parametrized through comparison with the known job descriptions using machine artificial intelligence and natural language processing. Job seeker information may be parametrized based on user-provided factual and historical data, possibly including but not limited to, location, employment history, military history, and certifications, as well as data acquired through the user performing tests, assessments, and games. Each job description and job seeker description is parametrized to the same set of well-defined parameters, which may comprise a set of competencies that typify both the job and the job seeker. The processed information obtained from parameterization may be used to compare job seekers and available jobs, determine a job-seeker's innate capabilities in career planning, determine analytics amongst the job-seeker population, or determine analytics amongst available jobs in a region or industry. Job seekers or employers may exchange computed parameters, for example, in the form of bar codes, or probability distributions with associated mean or median values which are then matched to provide the best optimized pairing.

In accordance with an aspect, an apparatus comprises: a first computing device that receives as inputs available job descriptions and job seeker descriptions, the first computing device comprising at least one processor and non-transitory memory the respectively run and contain a program comprising: parameterization instructions that parameterize the available job descriptions and parameterize the job seeker descriptions to a common set of well-defined parameters, thereby generating parameterized available job descriptions and parameterized job seeker descriptions; and comparison instructions that generate ranked matches between pairings, each pairing comprising one of the parameterized available job descriptions and one of the parameterized job seeker descriptions. In some implementations the common set of well-defined parameters is derived from a set of generic job descriptions. In some implementations the parameterization instructions parameterize the generic job descriptions to derive the common set of well-defined parameters. Some implementations comprise a natural language processor that identifies statements that relate to competencies required for each of the generic job descriptions. Some implementations comprise a natural language processor that identifies, in one of the available job descriptions, statements that relate to competencies required for each of the generic job descriptions. In some implementations ones of the statements include one or more of an ability, an interest, work value, work style, a skill, knowledge, education level, training level, experience level, work activity, organizational context, work context, location, pay level, growth potential, and environmental friendliness. In some implementations the comparison instructions assign a value to each statement to qualify the statement or quantify a level to which the statement applies. In some implementations at least one of the job seeker descriptions comprises self-descriptive factual data. In some implementations at least one of the job seeker descriptions comprises comparison to previous job seekers. In some implementations the at least one job description comprises assessment data obtained via testing of a job seeker. In some implementations testing comprises a game. Some implementations comprise instructions that perform at least one of: compare job seekers and available jobs; determine a job-seeker's innate capabilities in career planning; determine analytics amongst the job-seeker population; and determine analytics amongst available jobs in a region or industry. Some implementations comprise an interface via which a first available job description is entered and a plurality of best matching job seeker descriptions for the first available job description are returned. Some implementations comprise an interface via which a first job seeker description is entered and a plurality of best matching available job descriptions for the first job seeker description are returned.

In accordance with an aspect, a method comprises: a first computing device: receiving as inputs available job descriptions and job seeker descriptions; parameterizing the available job descriptions and the job seeker descriptions to a common set of well-defined parameters, thereby generating parameterized available job descriptions and parameterized job seeker descriptions; generating matches between pairings comprising one of the parameterized available job descriptions and one of the parameterized job seeker descriptions; and generating ranked matches between pairings. Some implementations comprise deriving the common set of well-defined parameters from a set of generic job descriptions. Some implementations comprise parameterizing the generic job descriptions to derive the common set of well-defined parameters. Some implementations comprise a natural language processor identifying statements that relate to competencies required for each of the generic job descriptions. Some implementations comprise a natural language processor identifying, in one of the available job descriptions, statements that relate to competencies required for each of the generic job descriptions. In some implementations identifying statements comprises identifying one or more of an ability, an interest, work value, work style, a skill, knowledge, education level, training level, experience level, work activity, organizational context, work context, location, pay level, growth potential, and environmental friendliness. Some implementations comprise assigning a value to each statement to qualify the statement or quantify a level to which the statement applies. In some implementations receiving the job seeker descriptions comprises receiving self-descriptive factual data and assessment data, and the method comprises obtaining the assessment data via testing of a job seeker. In some implementations receiving the job seeker descriptions comprises receiving self-descriptive factual data. In some implementations receiving the job seeker descriptions comprises receiving a comparison to previous job seekers. In some implementations receiving the job seeker descriptions comprises receiving assessment data obtained via testing of a job seeker. In some implementations testing comprises a job seeker playing game. Some implementations comprise performing at least one of: comparing job seekers and available jobs; determining a job-seeker's innate capabilities in career planning; determining analytics amongst the job-seeker population; and determining analytics amongst available jobs in a region or industry. Some implementations comprise receiving a first available job description via an interface and returning a plurality of best matching job seeker descriptions for the first available job description via the interface. Some implementations comprise receiving a first job seeker description via an interface and returning a plurality of best matching available job descriptions for the first job seeker description via the interface.

### BRIEF DESCRIPTION OF THE FIGURES

FIG. 1 is a block diagram of a system for comparing people and jobs by parameterizing job descriptions and job seeker descriptions to a common set of well-defined parameters.

FIG. 2 illustrates a computer network in which the system of claim 1 may be implemented.

FIG. 3 illustrates elements of a job-related API hosted by the parameterization compute engine of FIG. 2.

FIG. 4 illustrates processing of the available job description in greater detail.

FIG. 5 illustrates processing of the job seeker description in greater detail.

FIG. 6 illustrates comparing of parameterized job descriptions from a plurality of available jobs with a parameterized job seeker description from a job seeker.

FIG. 7 illustrates comparing of a parameterized job description from an available job with parameterized job seeker descriptions from a plurality of job seekers.

FIG. 8 illustrates operation of the computer AI interfaces in greater detail.

### DETAILED DESCRIPTION

Some aspects, features and implementations described herein may include machines such as clouds, networks, servers, compute engines, computers, personal computers, tablets, mobile phones, electronic components, optical components, a wide variety of other devices that include at least one processor and non-transitory memory, and processes such as computer-implemented steps. Although the terms “computer” and “compute engine” may be used in the following description, those terms are not intended to be limiting and should be interpreted broadly to possibly include but not be limited to any of the aforementioned machines. It will be apparent to those of ordinary skill in the art that the computer-implemented steps may be stored as computer-executable instructions on a non-transitory computer-readable medium. Furthermore, it will be understood by those of ordinary skill in the art that the computer-executable instructions may be executed on a variety of tangible processor devices. For ease of exposition, not every step, device or component that may be part of a compute engine, computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

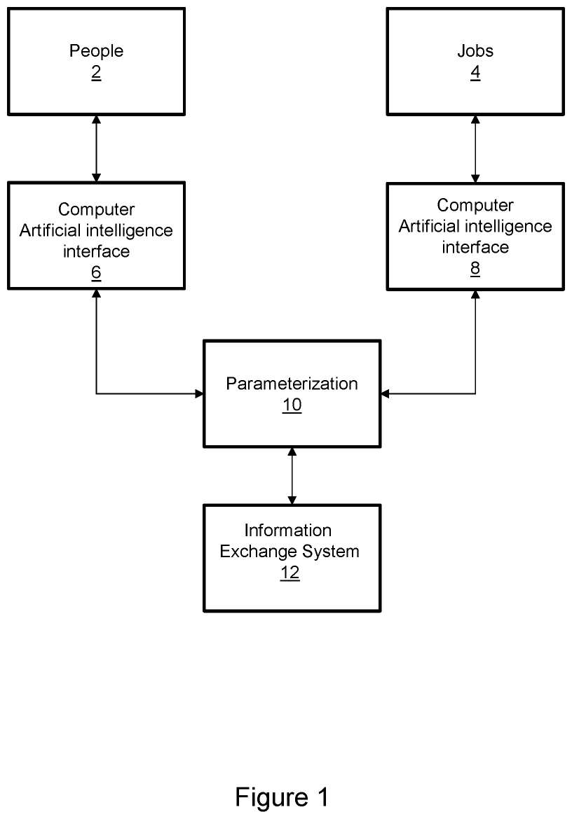

Referring to FIG. 1, people 2 are compared with jobs 4 by an information exchange system 12 using computer artificial intelligence interfaces 6, 8 and parametrization 10. For example and without limitation, available jobs may be compared with job seekers. Information that describes the people and the jobs may be obtained from a wide variety of sources. Rather than simply being matched, e.g. through keywords, both information about the jobs and information about the people are parametrized by parameterization 10 to a common set of well-defined parameters and then compared by the information exchange system 12. More particularly, the job information and the information about the people are both parametrized to a common set of well-defined parameters that may be derived from a database of standard or generic job descriptions or job-related API. A parameter may define any characteristic that can help in describing or classifying the people and the jobs. For example, parameters may be selected to disambiguate the language of job descriptions and job seeker descriptions by avoiding, translating or qualifying terms that have different meanings in association with different job seekers and job descriptions. The artificial intelligence interfaces may include one or more of a webpage, a computer application, and an application that can be executed on a mobile phone, tablet, or other portable computing device. Both job seekers and employers can access the information exchange system via the computer artificial intelligence interfaces to provide information and obtain output such as possible matches.

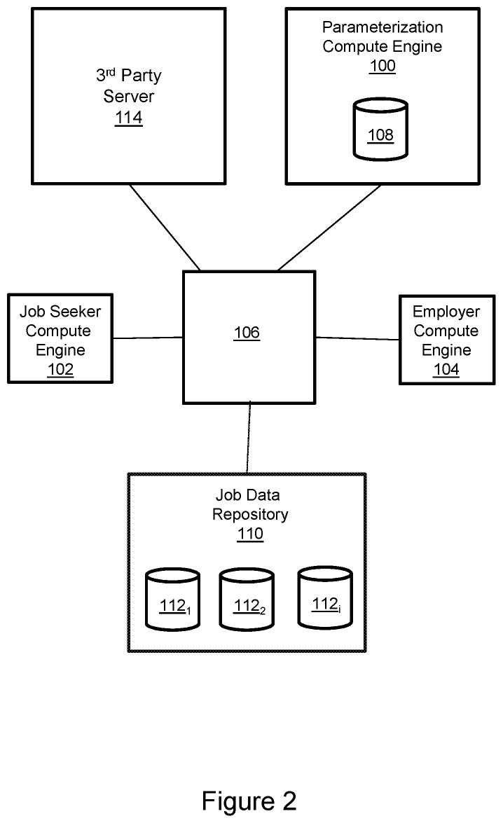

Referring to FIG. 2, a computer network in which the system of FIG. 1 may be implemented may include a parameterization compute engine 100, a job seeker compute engine 102, an employer compute engine 104, a job data repository 110, a third party server 114, and an interconnecting network 106. The parameterization compute engine 100 may include persistent data storage 108. The job data repository 110, of which there may be more than one, may include persistent data storage drives 112₁ through 112ᵢ on which the database(s) of standard or generic jobs is/are maintained. The third party server 114 may host a job finding or employee finding application or website, for example and without limitation. The job seeker compute engine 102 may be a cloud, server, mobile device, a personal computing device or a computing device of an employment agency, for example and without limitation. The employer compute engine 104 may be a cloud, server, mobile device, a personal computing device or server of a business, for example and without limitation. The job data repository may be a storage server or data center of a governmental and/or private organization, for example and without limitation. In some implementations the job data repository includes hundreds or thousands of accumulated job descriptions from years of job listings in a wide variety of different jobs. The job descriptions in the job data repository are not necessarily associated with currently open jobs. For example, the job descriptions may include historical job descriptions or general descriptions of different types of jobs that are not uniquely associated with any specific job opening. The job descriptions provided by the job data repository will hereafter be referred to as generic job descriptions.

Job descriptions associated with available jobs may be provided via the employer compute engine 104. Job seeker descriptions about the people seeking jobs may be entered via the job seeker compute engine 102. The job descriptions and job seeker descriptions are provided to the parameterization compute engine 100, either directly or via a job-related program hosted by the 3^{rd} party server 114. The parameterization compute engine 100 parameterizes the job descriptions and the job seeker descriptions to a common set of well-defined parameters that are derived from the generic job descriptions in data storage 112 of the job data repository 110, thereby generating job parameterization profiles and job seeker parameterization profiles. Once parameterized, the job seekers can be compared with the job descriptions using the common set of well-defined parameters for purposes that may include but are not limited to finding potential suitable matches between parameterization profiles. Parameters, job information, job seeker information, and a variety of other data may be stored in data storage 108.

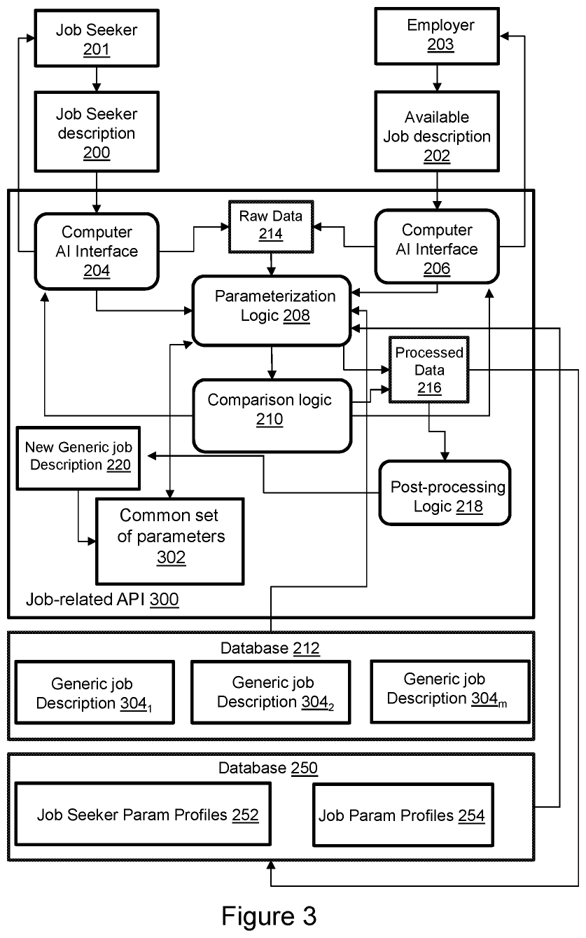

Referring to FIG. 3, the parameterization compute engine may host a job-related API (application programming interface) 300 that includes computer AI (artificial intelligence) interface 204, computer AI interface 206, parameterization logic 208, and comparison logic 210. The parameterization logic 208 receives or derives a common set of well-defined parameters 302 from a database 212 of generic job descriptions 304₁-304ₘ. The generic job description records in database 212 may each include a generic job title and a generic text description of the job. Generic job titles are not used as parameters, but may be parameterized by the parameterization logic 208. The generic jobs database 212 may include descriptions of the most common jobs across all or many industries. In more specific applications for a certain industry the generic jobs database may represent the most common jobs in that specific industry. These jobs and their corresponding parametrization to derive the common set of well-defined parameters 302 represent the basis upon which the available jobs are processed and compared with job seekers.

A job seeker description 200 is provided by a job seeker 201 via computer AI interface 204. Interface 204 may be presented on the job seeker compute engine or accessed by the application hosted by the 3^{rd} party server. An available job description 202 is provided by an employer 203 via computer AI interface 206. Interface 206 may be presented on the employer compute engine or accessed by the program hosted by the 3^{rd} party server. The job seeker description 200, the available job description 202 and a plurality of other job seeker descriptions and available job descriptions may be processed in real time and/or stored as raw data 214 for subsequent processing. The stored raw data 214 or, in real-time, the job seeker description 200 or available job description 202, is parameterized by the parameterization logic 208 to the common set of well-defined parameters 302 that was derived from the generic job descriptions in database 212. The parametrized results may be provided to comparison logic 210 and/or stored as processed data 216. For example, the parameterized job descriptions and parameterized job seeker descriptions may be processed by the comparison logic 210, either immediately or at a later time, to find and rank possible matches between job seeker parameterization profiles and available job parameterization profiles, and thus matches between job seeker descriptions and job descriptions. The possible matches may be provided to the job seeker 201 via computer AI interface 204, to the employer 203 via computer AI interface 206, and/or stored as processed data 216. Post processing logic 218 may further process the processed data 216 to generate a new generic job description 220 that may contribute to the database 212 or be added an independent database of job descriptions. Job seeker parameterization profiles 252 and/or job parameterization profiles 254 from the processed data 216 may be organized and stored in a database 250, e.g. to facilitate processing of subsequently created job seeker parameterization profiles and job parameterization profiles for a wide variety of purposes.

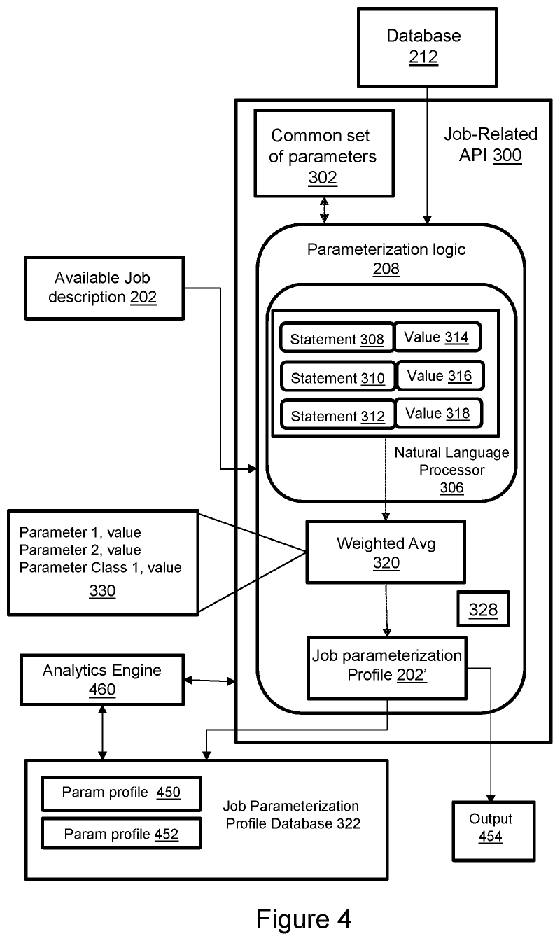

FIG. 4 illustrates processing of an available job description in greater detail. In the illustrated example an available job description 202 is provided as input to the parameterization logic 208 of job-related API 300. The available job description 202 may include a job title and a text description of a particular job that is currently available or will become available. A natural language processor 306 and machine artificial intelligence may be used to parameterize the available job description 202 to the common set of well-defined parameters 302 derived from database 212 of generic jobs. For example, the natural language processor 306 may parameterize the generic job descriptions of database 212 to identify statements 308, 310, 312 (of which there may be many) that relate to competencies required for each of the generic job descriptions. The natural language processer may parameterize the available job description 202 based on the statements 308, 310, 312. The statements may include, but are not limited to, one or more of abilities, interests, work values, work styles, skills, knowledge, education level, training level, experience level, work activity, organizational context, work context, location, pay level, growth potential, or environmental friendliness. Parameterization may include finding common meaning, keywords, phrases and word fragments associated with common parameters within the generic and available job descriptions. Values 314, 316, 318 are assigned to each statement based on results of the comparison. The values may qualify whether the statement is common to both a generic job description and the available job description or quantify a level to which that statement applies. For example, the value may indicate a skill level required for that statement to the job, or a level of importance of that statement to the job. The values may be used as matching coefficients that quantify matching between individual statements in the generic job descriptions and the available job description 202. The set of values associated with statements from a particular generic job description may be combined to generate a single matching coefficient between the available job description and a particular generic job, e.g. indicating how closely the inputted available job description 202 matches generic job description 304₂ (FIG. 3). In some cases the same statement may appear multiple times with different values, for example, one reflecting level and another reflecting importance.

The parameterization logic 208 may calculate a weighted average 320 of the statements associated with one or more generic job descriptions of database 212 based on the values in order to generate a job parameterization profile 202′, which is the parameterization profile of available job description 202. Using the values for each parameter and parameter class in a parameter set 330 for each generic job description, the parametrization of available job description 202 may be determined through a weighted averaging methodology of each parameter in the parameter set with the weight being the matching coefficient between a generic job description and the available job description 202. The weighted average calculation may include a variety of functions, for example and without limitation, a linearly weighted average, square root of the sum of the squares, or other such weighing mechanisms. The result is job parametrization profile 202′ of the inputted available job description 202. The job parameterization profile 202′ may be provided as output 454 and/or stored as processed data in a job parameterization profile database 322 along with other job parametrization profiles 450, 452 of other available job descriptions. The job parameterization profiles of database 322 may be processed by an analytics engine 460 for any of a wide variety of purposes.

Mathematically, each generic job description PJⱼ can be expressed as a set of values for each skill in the parameter set as {s_{i,j}}, where subscript i represents each skill in the parameter set, subscript j represents each generic job description, and s is the relational value for a particular generic job description and parameter in the parameter set. This relational value represents the level of importance of the parameter, relevancy, or level required for that generic job. Using the artificial machine intelligence, each available job description can be expressed as a set of relational values {qⱼ} to each generic job description j. Each available job can be parametrized to each skill in the parameter set as:

$$\{ {( {\sum }_{j} {q}_{j}^{a} {s}_{ij}^{b} )}^{c} \} = \{ {J}_{i} \}$$

where a, b, and c are exponential powers, for example a=b=c=1, or a=b=2 and c=½. The resulting set {Jᵢ} is the unique job parametrization profile 202′ for available job description 202. A database 328 of statements associated with a wide variety of generic job descriptions may be created and refined over time to provide more accurate or more specific competencies or parameters that are relevant to matching.

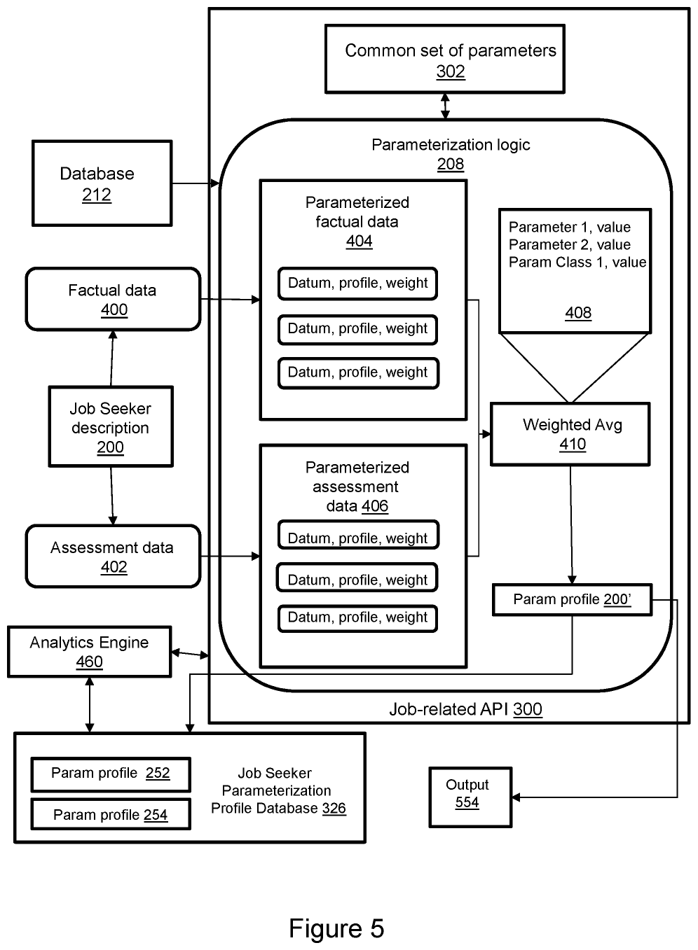

FIG. 5 illustrates processing of a job seeker description in greater detail. Each job seeker description, e.g. job seeker description 200, may include both self-descriptive factual data 400 and assessment data 402. The self-descriptive factual data 400 may include, but is not limited to, one or more of geographic region, years of experience working, education level, education history, employment history, military history, certifications, hobbies, clubs, and organizational memberships. For example, in the case of military experience the job seeker may enter the MOS (Military Occupation Specialty) Code and the length of time the job seeker held that position. In some implementations the self-descriptive factual data may include physical limitations that the job seeker might have, for example and without limitation, limited finger dexterity, or lifting limitations. The assessment data 402 may be acquired through testing of the job seeker. The testing may include but is not limited to one or more of games, quizzes, and questions designed to obtain data regarding job seeker personality, specific preferences regarding jobs, and specific levels of various skills. The factual data 400 is parameterized by the parameterization logic 208 of job-related API 300 to generate parameterized factual data 404. The assessment data 402 is parameterized by the parameterization logic to generate parameterized assessment data 406. Each data element has a specific value for each parameter in the parameter set. For example, each MOS Code has a specific value for each parameter in the parameter set. In the case of education history, the job seeker may enter the educational institution, and, if applicable, any departments in which the job seeker has studied, and the extent of those studies. Each department and certificate has a specific value for each parameter in the parameter set. In the case of employment history the job seeker may enter job titles and the length of time holding those job titles. Each job title has a specific value for each parameter in the parameter set as determined through the parametrization logic (job titles are not parameters, but may be parameterized). For the remaining factual data, e.g. certification, hobbies, clubs, and organizational memberships, each is assigned a specific value for each parameter in the parameter set. The job seeker is assigned a set of parameters 408 to be compared with available jobs parameters, in a similar format, or distribution of same using an artificial intelligence method. In the illustrated example the job seeker is assigned the same set of parameters against which the available job descriptions are parametrized, i.e. the common set of well-defined parameters 302 obtained by parameterizing the generic job descriptions in database 212.

The parameterization logic may calculate a weighted average 410 of the parameterized factual and assessment data to generate a job seeker parameterization profile 200′, which is the parameterization profile of job seeker description 200. The weighted average may be calculated using any of a wide variety of functions, which may include but are not limited to a linearly weighted average, square root of the sum of the squares, or other such weighing mechanisms. The result is a unique job seeker parameterization profile 200′ for job seeker description 200 based on the common set of well-define parameters 408. The parameterization profile 200′ may be provided as output 554 and/or stored as processed data in a database 326 of job seeker parameterization profiles along with other job seeker parametrization profiles 252, 254. The job seeker parameterization profiles of database 326 may be processed by the analytics engine 460 for any of a wide variety of purposes.

Mathematically, each factual or assessed datum k possible for a job seeker can be expressed as a set of values for each skill in the parameter set as {s_{i,k}}, where subscript i represents each skill in the parameter set, subscript k represents each fact or assessment, and s is the relational value for the fact or assessment and the parameter in the parameter set. This relational value represents the level of importance, relevancy, or level required for that parameter for the job. A relational value between each fact or assessment k and the job seeker in set {rⱼ} can be calculated. Each job seeker can therefore be parametrized to each skill in the parameter set as

$$\{ {( {\sum }_{k} {r}_{k}^{a} {s}_{ik}^{b} )}^{c} \} = \{ {U}_{i} \}$$

where a, b, and c are exponential powers, for example a=b=c=1, or a=b=2 and c=½. The resulting set {Uᵢ} is the job seeker parameterization profile 200′.

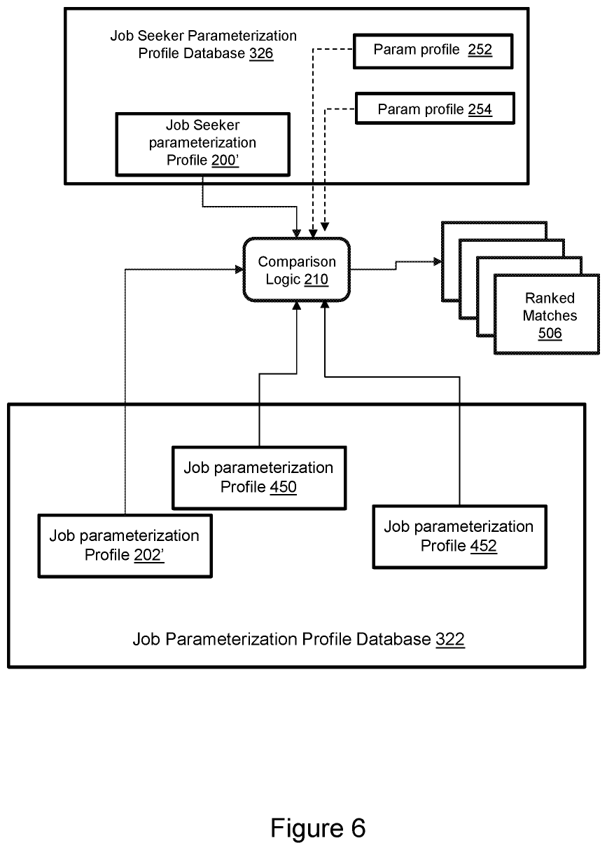

FIG. 6 illustrates comparison of job parameterization profiles from a plurality of available jobs and a job seeker parameterization profile from a particular job seeker. In the illustrated example job seeker parameterization profile 200′ from database 326 and job parameterization profiles 202′, 450, 452 from database 322 are inputted to comparison logic 210 of the job-related API. The comparison logic calculates ranked matches 506. Each pairing in the ranked matches indicates the extent to which job seeker parameterization profile 200′ matches one of the job parameterization profiles 202′, 450, 452. The ranking may be qualitative or quantitative, for example and without limitation, in the form of a matching percentage, or relative ranking such as far match, medium match or close match. The ranked matches may include the associated job seeker and available job descriptions.

There may be a parametrization weight for each parameter in the parameter set, which is the weighted value by which the values in the job seeker parametrization profile and the job parametrization profile are compared. In some implementations the parametrization weight is a dynamic variable that changes based on job seeker input/click history. That is, as the job seeker selects various available jobs, the variables that are critical to that job seeker will increase in weight. For each parameter, the values in the parameter set for both the user parametrization profile and the job parametrization profile, along with the weight from the parametrization weight, are used in the comparison algorithm to determine a matching parameter. This weighted comparison may involve a number of functions, which may include but are not limited to a Jaccard Similarity, a L1 Similarity, a weighted Jaccard Similarity function, a weighted L1 Similarity function, or a Modified Jaccard Similarity function.

Mathematically, given sets {Jᵢ} and {Uᵢ} representing the job parameter profile and the job seeker parameter profile, respectively, a matching parameter can be expressed for each available job as:

$$L = 1 - {( \frac{{( {\sum }_{i} min ( {J}_{i} , {U}_{i} ) )}^{a}}{( {\sum }_{i} {max ( {J}_{i} , {U}_{i} )}^{b} )} )}^{c}$$

where a, b, and c are exponential powers, for example a=b=c=1, which is the Jaccard Similarity Function, or a=b=2 and c=½ which is a Modified Jaccard Similarity Function.

In some implementations, matching parameter L may be modified to reflect similarities to other people, e.g. using the database 326 of job seeker parameterization profiles. The comparison logic 210 functions in the same manner as previously described except that each of the job seeker parameterization profiles 200′, 252, 254 are compared to each other. These other job seekers have previously interacted with the job-related API, and the previous jobs selected, applied, or clicked by those previous job seekers are stored. If a user of a matching parameter greater than a threshold value has interacted with a job with a parametrization profile greater than a threshold value of the job of interest, matching parameter L will be increased. The comparison logic 210 might also be used to compare each of the job parameterization profiles to each other.

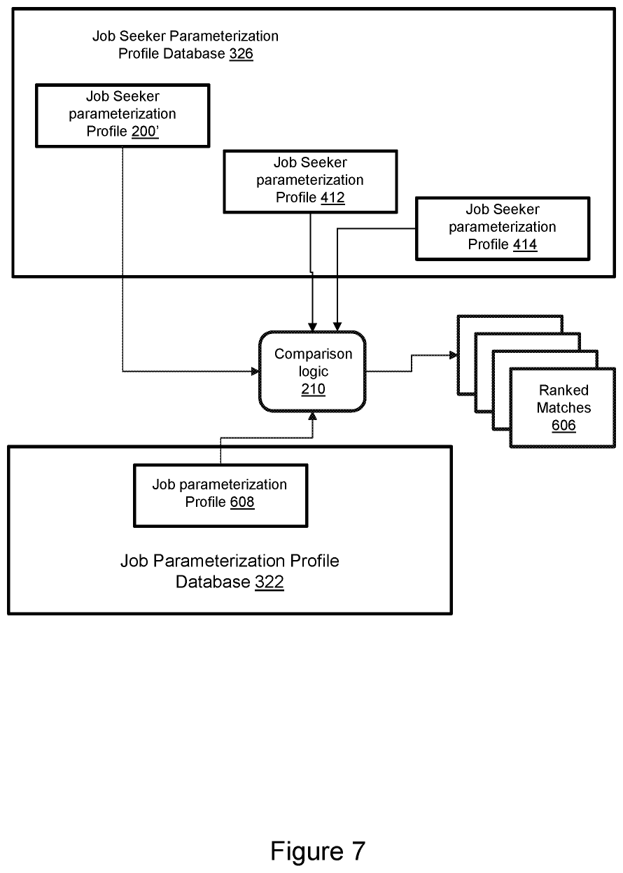

FIG. 7 illustrates comparison of a job parameterization profile from a single available job in database 322 with job seeker parameterization profiles from a plurality of job seekers in database 326. The comparison logic 210 functions in the same manner as previously described except that each of the job seeker parameterization profiles 200′, 412, 414 is compared with a single job parameterization profile 608. The output, i.e. ranked comparison values 606, indicates how well each of the job seeker parameterization profiles matches the selected job parameterization profile 608. Thus, the system can be used to find either the best matching available jobs for a job seeker or to find the best matching job seekers for an available job.

Although the inventive concepts are not limited by any particular advantages it will be apparent to those of ordinary skill in the art in view of the present disclosure that at least some of the drawbacks of the prior art may be overcome or at least mitigated with some of the concepts described above. For example, a job seeker may be matched to different types of jobs rather than being limited to a single type of job because a job seeker parameterization profile may correlate with job parameterization profiles associated with a variety of different types of jobs. Moreover, suitable applicants may be found for jobs that are new or are not described using widely known titles or terms. For example, a Cake Decorator may be a niche specialty that is absent from the database of generic jobs. However, the job-related API may determine via parameterization that a Cake Decorator has a 40% match to the parameters of a Baker, a 20% match to the parameters of an Artist, and a 20% match to the parameters of a Florist. Thus, the job-related API could match a job seeker with experience as a baker, artist and florist with a job opening for a Cake Decorator even though the job seeker did not indicate (and would not have thought to indicate) a specific interest in cake decorating. Moreover, a new job description for Cake Decorator could be created and added to the database of generic job descriptions. Such comparison and matching of job seekers and available jobs are not practical with current state of the art keyword comparisons.

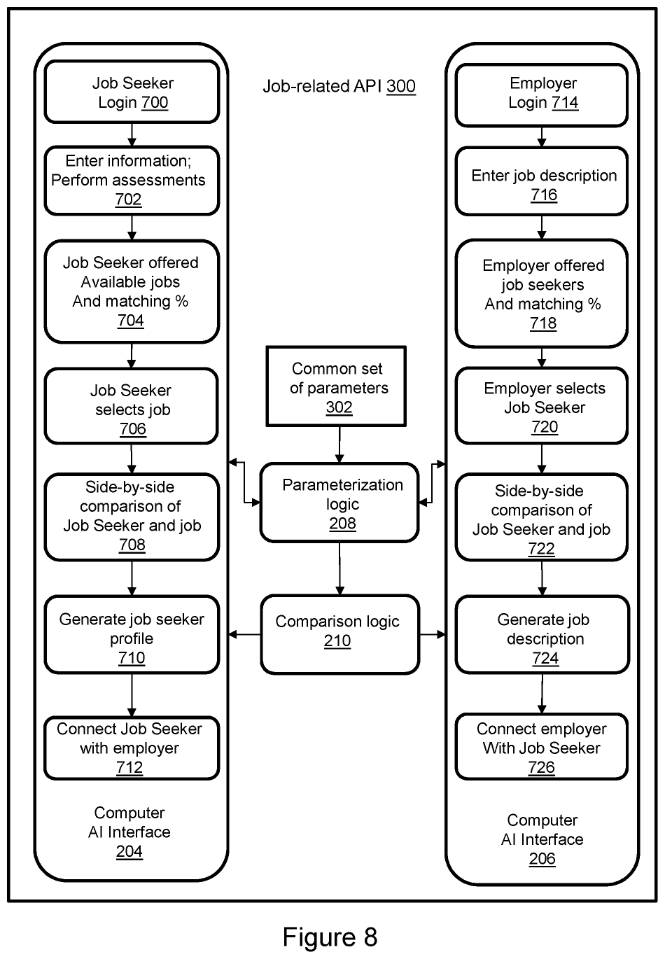

FIG. 8 illustrates operation of the computer AI interfaces 204, 206 in greater detail. The artificial intelligence interfaces 204, 206 may be presented as job-related API 300, a website, a webpage, and a computer application, e.g. and without limitation a client application that can be executed on a job seeker compute engine and employer compute engine such as a cloud, network, server, personal computer, mobile phone, tablet, or other portable computing device. Both of the AI interfaces 204, 206 may be integrated into a single interface.

A job seeker may login with a username and password as indicated in block 700. The job seeker would enter information and perform assessments as indicated in block 702 in order to provide factual data and assessment data. The parameterization logic 208 processes the factual data and assessment data as already described above using the common set of well-defined parameters 302. Comparison logic 210 uses the parameterization profiles as already described above and presents ranked available jobs, e.g. with comparison %, as indicated in block 704. The job seeker may select one or more of the presented jobs as indicated in block 706. The interface may present a side-by-side comparison of the job seeker and the available job as indicated in block 708. For example, the job description and job seeker description could be shown. The interface may generate a job seeker profile as indicated in block 710. In response to input from the job seeker the interface connects the job seeker with an employer associated with a selected presented job as indicated in block 712.

An employer may login with a username and password as indicated in block 714. The employer would enter a job description as indicated in block 716. The parameterization logic 208 processes the job description data as already described above using the common set of well-defined parameters 302. Comparison program 210 uses the parameterization profiles as already described above and presents ranked job seekers, e.g. with comparison %, as indicated in block 718. The employer may select one or more of the job seekers as indicated in block 720. The interface may present a side-by-side comparison of the selected job seeker and the entered job as indicated in block 722. The interface may generate a job description as indicated in block 724. In response to input from the employer the interface connects the employer with the selected job seeker as indicated in block 726.

A wide variety of features and variations are possible. In some implementations, the job seeker may download and save the job seeker parametrization profile in such a way that it is presentable to a potential employer. In some implementations the job seeker may be able to contact the employer within the application directly, e.g. through a communications component within the application. In some implementations the job seeker may ‘save’ jobs of interest to return to considering them at a later time. In some implementations, all user activities, possibly including, but not limited to jobs clicked and jobs saved, are recorded and used to further modify the matching algorithm. In some implementations all user activities listed above can also be performed by an employer with a job description looking for job seekers. Employers may enter a job description or select the parameters from the parametrization dataset and assign values to those parameters which are most applicable to the job they are filling.

A number of features, aspects, embodiments and implementations have been described. Nevertheless, it will be understood that a wide variety of modifications and combinations may be made without departing from the scope of the inventive concepts described herein. Accordingly, those modifications and combinations are within the scope of the following claims.

What is claimed is:

1. A method of matching job seekers to available jobs, the method comprising the steps of:
storing, in databases,
a plurality of generic job competencies including an ability, education, and experience;
a plurality of generic job descriptions; and
a set of generic job competency relational values matched to each generic job description of the plurality of generic job descriptions, the generic job competency relational values representing a level of importance of each generic job competency to the generic job description;
receiving, via a graphical user interface, an available job description as a text input including statements of available job competencies including an ability, education, and experience;
comparing the available job description with each generic job description of the plurality of job descriptions;
generating a set of matching coefficients wherein each matching coefficient represents how closely each generic job description of the plurality of generic job descriptions matches the available job description;
using the set of matching coefficients and the set of generic job competency relational values to generate a set of available job relational values;
storing, in an available job database, available job descriptions and corresponding available job relational values;
receiving, via a graphical user interface, job seeker data including self-descriptive factual data and job seeker assessment data;
using the plurality of generic job competencies, to identify job seeker competencies in the job seeker data;
generating a set of job seeker relational values between the job seeker competencies and the generic job competencies, wherein the set of job seeker relational values is based on the job seeker competencies and the set of generic job competency relational values;
storing, in a job seeker database, the job seeker data and the set of job seeker relational values;
generating a set of matching competencies between the available job descriptions and the job seeker data by comparing the set of job seeker relational values and available job relational values;
storing, in a job seeker profile database, the matching competencies between each job in the available job database and each job seeker.

2. The method of claim 1, wherein the step of storing, in databases, further comprises the step of:
storing generic job descriptions as text.

3. The method of claim 2, wherein the step of receiving, via a graphical user interface, job seeker data including factual data and assessment data, further comprises the step of:
receiving military experience or military occupation codes pertaining to the job seeker.

4. The method of claim 1, further comprising the step of:
displaying, on a graphical user interface, available jobs in the available jobs data base and the matching competencies, wherein the displayed available jobs and matching competencies correspond to the job seeker data.

5. The method of claim 1, further comprising the step of:
displaying, on a graphical user interface, available job seekers in the available seeker database and associated matching competencies, wherein the displayed available jobs and matching competencies correspond to the available job.
